(19) United States
(12) Patent Application Publication
(10) Pub. No.: US 2010/0170098 A1
(43) Pub. Date: Jul. 8, 2010

(54) KITCHEN SLICER

(76) Inventor: Juergen BOERNER, Landscheid-Niederkail (DE)

Correspondence Address: HARNESS, DICKEY & PIERCE, P.L.C., P.O. BOX 828, BLOOMFIELD HILLS, MI, 48303, US

(21) Appl. No.: 12/683,488

(22) Filed: Jan. 7, 2010

Related U.S. Application Data
(63) Continuation of application No. PCT/EP08/05660, filed on Jul. 10, 2008.

(30) Foreign Application Priority Data
Jul. 10, 2007 (DE) 10 2007 032 070.3

(51) Int. Cl. B26B 27/00

(52) U.S. Cl. 30/279.2

(57) ABSTRACT

A kitchen slicer for cutting items to be cut, such as fruit, vegetables etc., comprising a base body to which a blade is fixed in order to cut pieces off from the item to be cut, a guide surface which is arranged offset in relation to the blade and on which the item to be cut can be moved back and forth and fed to the blade in a controlled manner, wherein the offset between the blade and the guide surface determines a cutting thickness of the pieces to be cut, an insert whose surface forms a guide surface and, as a whole, can be moved and can be fixed to the base body in different positions, in order to thus realize different cutting thicknesses, and fixing means which fix the insert relative to the base body, wherein the fixing means have at least one component which is produced separately from the base body and from the insert and is mounted such that it can move relative to the base body in order to fix and to release the insert.

### CROSS-REFERENCE TO RELATED APPLICATIONS

This is a Continuation application of International patent application PCT/EP 2008/005660, filed Jul. 10, 2008 which was published in the German language and claims the priority of German patent application DE 10 2007 032 070, filed Jul. 10, 2007. The entire contents of these applications are incorporated herein by reference.

### BACKGROUND OF THE INVENTION

The present invention relates to a kitchen slicer for cutting items such as fruit, vegetables, etc. The kitchen slicer according to the present invention comprises a basic body on which a blade is secured in order for pieces to be cut off from the item, a guide surface which is offset in relation to the blade and on which the item can be moved back and forth and fed in a controlled manner to the blade, the offsetting between the blade and the guide surface determining a cutting thickness of the pieces which are to be cut, an insert, the upper surface of which forms the guide surface and which can be moved as a whole and secured in different positions on the basic body in order thus to realize different cutting thicknesses, and securing means which secure the insert relative to the basic body.

Such kitchen slicers are used for the defined comminution of items such as, for example, fruit, vegetables and the like. The slicer in this case is held in one hand, e.g. by a handle, and is supported, by an end located opposite the handle, on a support or a bowl. The item which is to be comminuted is moved back and forth on the guide surface and fed to the blade, which is arranged transversely or obliquely in relation to the main axis of the kitchen slicer or else is of V-shaped design. With each movement of the item over the blade, a slice is cut off from the item and drops through a slot between the blade and guide surface. The guide surface may contain additional cutting elements which serve for comminuting the item as it moves over the guide surface and therefore cut the item into strips.

The guide surface is configured in some cases separately from the basic body as an interchangeable insert. In order to adjust cutting thicknesses, this insert can be secured in different positions on the basic body and exchanged for differently configured inserts, e.g. with additional cutting elements, in order thus for different cutting variants to be provided.

DE 103 28 506 B4 discloses a kitchen slicer which has an interchangeable insert and in which the insert can be inserted into the basic body in different positions and different cutting-thickness settings can thus be realized, one position serving as a safeguard against injury.

DE 100 54 174 B4 discloses a kitchen slicer in which the cutting thickness is realized by virtue of an interchangeable insert being offset. The insert here can form either the guide surface of the kitchen slicer. The interchangeable insert here is secured on the basic body by way of clamping means and, by virtue of the clamping means being released, can be moved into a different position, for the purpose of changing the cutting thickness, without the insert having to be removed from the basic body. The different positions of the insert are realized here by parallel offsetting by means of a parallel guide or by pivoting by means of a pivoting guide.

In a particular embodiment of this kitchen slicer, the interchangeable insert can be offset parallel by guide pegs of the insert being displaced in ramp-like groove portions of the basic body. The insert here is secured in a longitudinal position in relation to the basic body by means of an elastically deflectable catch which is arranged on the basic body and engages in grooves formed in the insert.

The disadvantage with such a locking catch is that it is difficult to release the bolt since the catch, owing to its function as a securing means, is of comparatively small configuration or else can be released accidentally during use if it is arranged in an easily accessible manner on the insert.

### BRIEF SUMMARY OF THE INVENTION

Accordingly, it is an object of the present invention to specify a kitchen slicer in which the operation of adjusting the cutting thickness is simplified and cannot take place accidentally.

According to a first aspect of the invention, this object is achieved, in the case of the slicer mentioned in the introduction, having a basic body on which a blade is secured in order for pieces to be cut off from the item, having a guide surface which is offset in relation to the blade and on which the item can be moved back and forth and fed in a controlled manner to the blade, the offsetting between the blade and the guide surface determining a cutting thickness of the pieces which are to be cut, having an insert, the upper surface of which forms the guide surface and which can be moved as a whole and secured in different positions on the basic body in order thus to realize different cutting thicknesses, and having securing means which secure the insert relative to the basic body, in that the securing means have at least one component which is produced separately from the basic body and from the insert and is mounted such that it can be moved relative to the basic body in order to secure and release the insert.

Furthermore, according to a second aspect of the invention, the above object is achieved, in the case of the slicer mentioned in the introduction, having a basic body on which a blade is secured in order for pieces to be cut off from the item, having a guide surface which is offset in relation to the blade and on which the item can be moved back and forth and fed in a controlled manner to the blade, the offsetting between the blade and the guide surface determining a cutting thickness of the pieces which are to be cut, having an insert, the upper surface of which forms the guide surface and which can be moved as a whole and secured in different positions on the basic body in order thus to realize different cutting thicknesses, and having securing means which secure the insert relative to the basic body, in that the basic body has an opening through which the securing means can be actuated.

Furthermore, according to a third aspect of the invention, the above object is achieved, in the case of the slicer mentioned in the introduction, having a basic body on which a blade is secured in order for pieces to be cut off from the item, having a guide surface which is offset in relation to the blade and on which the item can be moved back and forth and fed in a controlled manner to the blade, the offsetting between the blade and the guide surface determining a cutting thickness of the pieces which are to be cut, having an insert, the upper surface of which forms the guide surface and which can be moved as a whole and secured in different positions on the basic body in order thus to realize different cutting thicknesses, and having securing means which secure the insert relative to the basic body, in that the securing means have a lever and a separate actuating element, it being possible for the actuating element to be brought into engagement with the lever in order to secure or release the insert.

Since the securing means have at least one component which is produced separately from the basic body and from the insert, it is possible for this component to be configured in any desired form and to be mounted such that it can be moved in any desired manner, in which case it is possible to realize a mechanically optimum form irrespective of the production process of the basic body or of the insert. Moreover, this separately produced component may consist of any desired material, irrespective of the material of the basic body or of the insert.

Furthermore, the securing means can be actuated particularly easily, and thus also released easily during use, through the opening, wherein the securing means are safeguarded, at the same time, against being released accidentally during use.

Furthermore, actuating means configured separately from the securing means are particularly straightforward to produce and easy to fit.

The first, the second and the third aspects of the invention can be ideally combined.

The object is achieved in full in this way.

It is preferred here if the opening is formed on a longitudinal side of the basic body, on a portion adjacent to the insert.

This arrangement of the opening relative to the insert allows the securing means to be of compact construction.

In a preferred embodiment, the lever is mounted such that it can be rotated about an axis of rotation.

The lever is thus particularly easy to move and, accordingly, the insert can be released with little force being applied.

It is preferred here if the actuating element is mounted such that it can be moved in a direction parallel to the axis of rotation.

Engagement between the actuating element and the lever can thus be realized particularly straightforwardly.

In a preferred embodiment, the securing means have an actuating portion via which the securing means can be actuated.

This actuating portion allows the securing means to be actuated particularly conveniently since the actuating portion can be adapted in shape and size, irrespective of the functioning of the securing means, to, for example, an average fingertip.

In one embodiment of the invention, the actuating portion is at least partially enclosed by the opening.

If the actuating portion is only partially enclosed by the opening, the securing means can be fitted particularly easily into the basic body.

In an alternative embodiment, the actuating portion is fully enclosed by the opening.

The actuating portion is thus safeguarded from all sides against being actuated accidentally, and the securing means are therefore safeguarded against being released accidentally during use.

In a preferred embodiment of the invention, the separately produced component has a two-sided lever.

This embodiment makes it possible to realize the securing means with a particularly straightforward mechanism, since a two-sided lever can easily be mounted in a rotatable manner.

In a preferred configuration, the two-sided lever is mounted such that it can be rotated about an axis arranged perpendicularly to the guide surface.

This configuration makes it possible for the two-sided lever to be arranged in a particularly space-saving manner in a design-specific elongate side part of the basic body, since a longitudinal axis of the two-sided lever thus runs parallel to the side parts of the basic body.

In a preferred configuration, the two-sided lever can be inserted into the basic body from a side which is directed away from the guide surface.

This configuration allows this separate component to be fitted with a low level of outlay since the basic body may be designed to be open, for example, on this side directed away from the guide surface and there is no need for any cover to be fitted once the two-sided lever has been fitted.

In a further configuration, the two-sided lever is mounted in a rotatable manner by means of a peg secured on the basic body.

This configuration makes it possible to dispense with high-outlay mechanisms for mounting the two-sided lever, since such a peg performs all the necessary functions for mounting such a lever.

In an alternative embodiment, the separately produced component has a slide which is mounted such that it can be moved transversely to an adjusting direction of the insert.

This embodiment allows the securing means to be realized in a particularly compact manner, as a result of which a more compact construction of the kitchen slicer as a whole is possible. This embodiment is particularly compact since it is possible to dispense with a lever arm.

In a further alternative embodiment, the securing means have a one-sided lever.

The advantage with a one-sided lever is that the latter is easy to produce and it can be made, possibly by injecting molding, as part of the basic body.

In a preferred configuration, the one-sided lever is mounted such that it can be moved relative to the basic body by means of a film hinge.

This configuration makes it possible to realize particularly cost-effective mounting for the one-sided lever since it can be produced, for example by injecting molding, together with the basic body.

In a particular configuration, the one-sided lever is connected integrally to the basic body.

This configuration of the one-sided lever makes it possible to dispense with the step of fitting the one-sided lever, since it is part of the basic body.

In a general embodiment, the securing means secure the insert in a form-fitting or force-fitting manner.

The insert can thus be secured particularly reliably on the basic body.

In a preferred configuration, the securing means are assigned an elastic element such that, in a non-loaded state, the securing means secure the insert relative to the basic body.

The insert is thus always secured relative to the basic body during use, without any additional force being applied by the user, as a result of which it is particularly convenient to use.

In a particular embodiment, the insert can be secured in a stepwise manner relative to the basic body.

This embodiment allows preferred cutting thicknesses to be selected in a direct and reproducible manner, since the insert can be secured only in certain positions.

In a preferred embodiment, the securing means have a catch, or latching nose or a bolt, and grooves, wherein the insert is secured in the different positions by virtue of the catch (of the bolt) engaging in a respective one of the grooves.

This mechanism allows the insert to be secured or released relative to the basic body with only a low level of force being applied, since the insert is secured by form fitting of the catch in one of the grooves, and all that is required in order to release the insert is for the form fit to be released.

In a preferred configuration, the catch and the grooves have such a profile that, by virtue of the insert being subjected to the action of force, the insert can be displaced with latching action in a first direction and locks in a direction which is counter to the first direction.

It is thus also possible for the insert to be displaced in the first direction during use without the actuating portion being actuated, in order for the cutting thickness to be changed quickly.

In one configuration, the grooves have a sawtooth profile.

This sawtooth profile makes it possible to realize the insert such that it can be moved particularly easily with latching action in one direction.

In an alternative embodiment, the insert can be adjusted in a stepless manner relative to the basic body.

This embodiment allows individual cutting thicknesses to be selected freely.

A particular configuration provides ramp guides on which sliding elements slide such that a displacement of the insert in the direction of the blade gives rise, at the same time, to the insert being offset perpendicularly thereto.

This configuration allows the insert to be displaced very conveniently relative to the basic body since, by virtue of the insert being subjected to the action of force in the direction of the blade, the cutting thickness changes. Since the kitchen slicer is usually held by a user at an end at which the insert is arranged, this force can be applied very easily, for example, by the thumb.

In a particular configuration, the ramp guide and the sliding elements interact such that the insert can be offset essentially parallel relative to the guide surface.

It is thus always equally easy to guide the item for cutting over the blade for different cutting thicknesses, since the item is always guided at an optimum angle over the blade.

The ramp guides are preferably at an angle of between 10° and 60° in relation to the guide surface.

This configuration allows the insert always to be displaced easily relative to the basic body, since the sliding elements do not skew in relation to the ramp guides and/or are not of self-locking design.

In a preferred configuration, the insert is of interchangeable design.

This makes it possible to realize further cutting variations, e.g. perpendicularly to the blade.

Of course, the abovementioned features, and those which are yet to be explained hereinbelow, can be used not just in the given combination, but also in other combinations or on their own, without departing from the framework of the present invention.

### BRIEF DESCRIPTION OF THE DRAWINGS

Exemplary embodiments of the invention will be explained in more detail in the following description and are illustrated in the drawing, in which:

FIG. 1 shows a perspective illustration of an embodiment of the kitchen slicer according to the invention with securing means;

FIG. 2 shows a schematic view of part of the basic body of an embodiment of the kitchen slicer according to the invention with a two-sided lever;

FIG. 3 shows a sectional view of the basic body and of the insert of a second embodiment of the kitchen slicer according to the invention, with a slide;

FIG. 4 shows a schematic view of part of the basic body and of the insert of a further embodiment of the kitchen slicer according to the invention;

FIG. 5 shows a schematic sectional view of the kitchen slicer for the purpose of explaining ramp guides;

FIG. 6 shows a perspective illustration of an embodiment of the insert of the kitchen slicer according to the invention;

FIG. 7 shows a schematic view of part of the basic body of an embodiment of the kitchen slicer according to the invention with a separate actuating element; and

FIG. 8 shows a schematic sectional view of the basic body and of the insert along line A-A in FIG. 7.

### DETAILED DESCRIPTION OF THE PREFERRED EMBODIMENTS

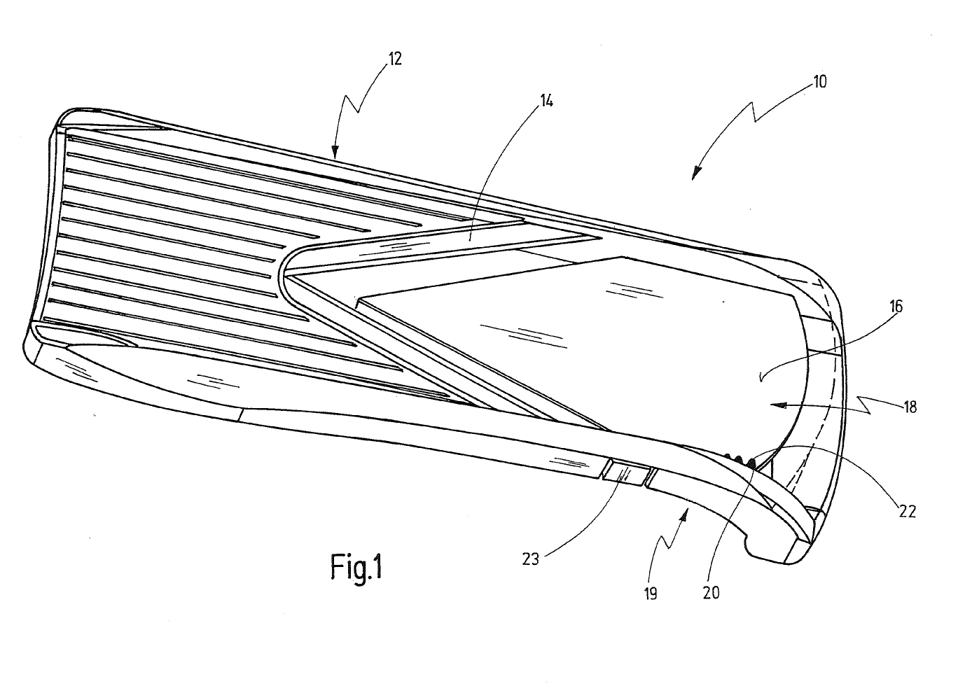

In FIG. 1, a first embodiment of the kitchen slicer according to the invention is designated in general terms by 10.

The kitchen slicer 10 has a basic body 12 on which a V-shaped blade 14 is secured. The blade 14 may be designed, as in this embodiment, as a V blade, although it is also possible for the blade 14 to be a rectilinear blade arranged obliquely or perpendicularly in relation to a main axis of the basic body 12.

A guide surface 16 is arranged opposite the blade 14. The guide surface 16 is formed by an insert 18. The kitchen slicer 10 also has securing means 19, which are arranged both on the basic body 12 and on the insert 18. The securing means 19 have a catch 20, grooves 22 and an actuating portion 23.

By means of the guide surface 16 of the insert 18, the item for cutting is fed in a controlled manner to the blade 14, a constant cutting thickness being obtained thereby. The item here is pressed onto the guide surface 16 and pushed over the blade 14, the cut item being removed through a gap between the blade 14 and the insert 18, the upper surface of which forms the guide surface. The cutting thickness is determined by offsetting between the guide surface 16 and the blade 14. This offsetting can be changed by different positions of the insert 18 relative to the basic body 12, and this therefore allows the cutting thickness to be varied. In order to be able to realize these different positions of the insert 18 relative to the basic body 12, the insert 18 is mounted such that it can be moved relative to the basic body 12. In order that the insert 18 is not moved along, during use, with the item for cutting, it can be secured relative to the basic body 12 by way of securing means 19. The securing means 19 have the catch 20 which engages in the grooves 22, formed on the insert 18, and thus secures the insert 18 relative to the basic body 12. The catch 20 is connected to the actuating portion 23. The actuating portion 23 is connected to the catch 20 such that actuation of the actuating portion releases the catch 20 from the grooves 22 and the insert 18 can thus be changed in position relative to the basic body 12.

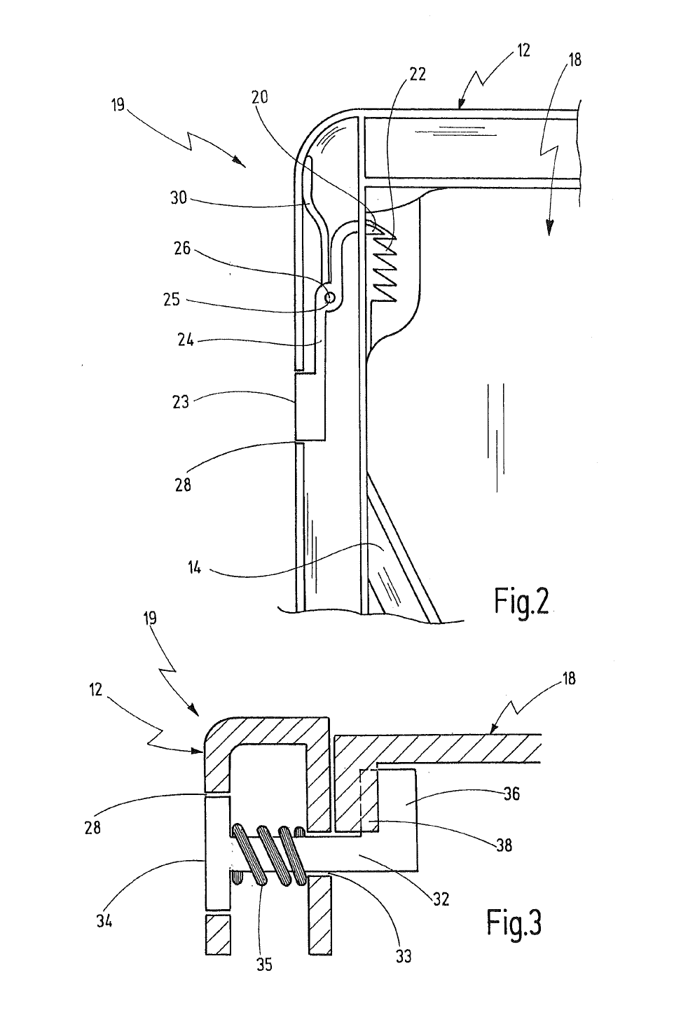

FIG. 2 illustrates, schematically, a view of part of the basic body 12 of the kitchen slicer 10 in a first embodiment, with a two-sided lever as the securing means 19.

The illustration in FIG. 2 shows the basic body 12 with the insert 18 from the side which is directed away from the guide surface 16. The insert 18 has the grooves 22, in which the catch 20 engages. The catch 20 is connected to a two-sided lever 24, which has a fastening hole 25. The two-sided lever 24 is mounted such that it can be rotated relative to the basic body 12, this being done by the fastening hole 25 being plugged onto a peg 26 which is secured on the basic body 12. The two-sided lever 24 has, at one end, the catch 20 and, at an end located opposite the catch 20, the actuating portion 23. The latter can be actuated through an opening 28 which is formed in the basic body 12. The two-sided lever 24 is connected to an elastic element 30, which has a free end supported on the basic body 12.

The insert 18 is secured relative to the basic body 12 in that the catch 20, which is connected to the basic body 12 via the two-sided lever 24, the fastening hole 25 and the peg 26, engages in one of the grooves 22. The elastic element 30 here is prestressed between the two-sided lever 24 and the basic body 12 such that the catch 20 engages in one of the grooves 22 without any force being applied externally, and secures the insert 18 relative to the basic body 12. Since the two-sided lever 24 is mounted such that it can be rotated relative to the basic body 12 by means of the fastening hole 25 and the peg 26, the catch 20 can be deflected laterally by virtue of the actuating portion 23 being subjected to the action of force, in which case the catch 20 and the grooves 22 are disengaged from one another. In this state, the insert 18 can be offset as desired relative to the basic body 12.

In a particular embodiment, the peg 26 may be connected integrally to the basic body 12. It is also conceivable for the peg 26 to be produced together with the basic body 12 by injecting molding. The embodiment which is illustrated in FIG. 2 illustrates the basic body 12 as a hollow body which is designed to be open on a side which is directed away from the guide surface, in which case the separately produced two-sided lever 24 can easily be introduced into the basic body 12 and fitted by virtue of being plugged onto the peg 26 by way of the fastening hole 25. It is particularly advantageous here for the fitting of the two-sided lever 24 if, as is illustrated in FIGS. 1 and 2, the opening 28 in the basic body 12 only partially encloses the actuating portion 23.

In this embodiment, the elastic element 30 is designed and arranged such that it forces the catch 20 into one of the grooves 22, without any force being applied externally, and thus secures the insert 18 relative to the basic body 12. It is thus the case, during use of the kitchen slicer 10, that the insert 18 is always secured in relation to the basic body 12 as long as the actuating element 23 is not actuated.

In this embodiment, the elastic element 30 is designed as a tongue which is curved in an S-shaped manner, one end being secured on the two-sided lever 24 and the free end being supported on an inner side of the basic body 12. The elastic element 30 may be formed from a material which differs from the material of the two-sided lever 24, or else it may be connected integrally to the two-sided lever 24. It is conceivable here for the elastic element 30 to be designed with a film hinge. A metallic leaf spring or a metallic helical spring can likewise be used as elastic element 30.

In this embodiment, the grooves 22 have a sawtooth profile, the catch 20 having a corresponding negative profile. It is thus possible, by virtue of the insert 18 in this embodiment being subjected to the action of force, for the insert 18 to be moved in the direction of the blade 14 without the actuating portion 23 being actuated. By virtue of the insert 18 being subjected to the action of force, the catch 20 is released from one of the grooves 22 and latches in again in another of the grooves 22. The sawtooth profile of the grooves 22 means that the insert 18 cannot be moved in the opposite direction.

As an alternative, the grooves 22 are designed such that latching displacement is not possible.

FIG. 3 illustrates a schematic sectional illustration of a second embodiment of the securing means of the kitchen slicer according to the invention, with a slide.

In this embodiment, the securing means 19 have a slide 32 which is mounted such that it can be moved axially in a through-passage 33 in the basic body 12. The slide 32 is connected to an actuating portion 34 which can be actuated through the opening 28. The slide 32 is assigned an elastic element 35 which is supported both on the actuating portion 34 and on the basic body 12. The slide 32 is connected to a catch 36 which engages in grooves 38 which are formed on the insert 18. The grooves 38 in this embodiment, due to the functioning of the slide 32, are formed preferably on an inner side of the insert 18, which is directed away from the basic body.

The elastic element 35, which in this particular embodiment is designed as a helical spring, is arranged, and prestressed, between the slide 32 and the basic body 12 such that, without the actuating portion 34 being subjected to the action of external force, the catch 36 engages with the grooves 38. By virtue of the actuating portion 34 being subjected to the action of force in the axial direction, the elastic element 35 is compressed and the catch 36 and the grooves 38 are disengaged from one another. In this state, the insert 18 can be offset relative to the basic body 12. If the actuating portion 34 is no longer subjected to the action of external force, the elastic element 35 forces the slide 32 into a starting position and brings the catch 36 and the grooves 38 into engagement, as a result of which the insert 18 is secured relative to the basic body 12. In a particular embodiment which has not been illustrated, the elastic element 35 may also be configured as a leaf spring.

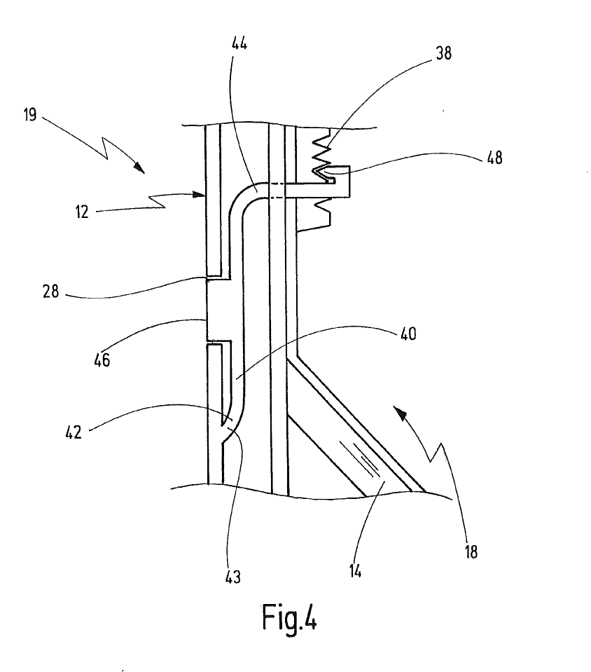

FIG. 4 illustrates, schematically, a third embodiment of the kitchen slicer according to the invention, with a one-sided lever.

The insert 18 is secured on the basic body 12 by means of a one-sided lever 40. The one-sided lever 40 is connected to the basic body 12 by way of a fixed end 42. A film hinge 43 is formed at the fixed end 42, and the one-sided lever 40 can therefore be moved elastically relative to the basic body 12. The one-sided lever 40 has a free end 44 located opposite the fixed end 42. Between the fixed end 42 and the free end 44, the one-sided lever 40 has an actuating portion 46, which can be actuated through the opening 28 in the basic body 12. Arranged at the free end 44 of the one-sided lever 40 is a catch 48 which engages in the grooves 38 on the insert 18 and thus secures the insert 18 relative to the basic body 12. The grooves 38 are formed preferably on that side of the insert which is directed away from the basic body 12.

Since a film hinge 43 is formed at the fixed end 42, the one-sided lever 40 can be deflected laterally, by virtue of the actuating portion 46 being subjected to the action of force, out of a rest position, in which the catch 48 engages in the grooves 38. This lateral deflection of the one-sided lever 40 disengages the catch 48 and the grooves 38 from one another, and the insert 18 can therefore be moved relative to the basic body 12. When the actuating element 46 is no longer subjected to the action of force, the film hinge, or restoring means (not illustrated), moves the one-sided lever 40 resiliently back into the rest position, and the catch 48 therefore engages again in one of the grooves 38 and secures the insert 18 relative to the basic body 12.

The one-sided lever 40 may be produced in a single piece with the basic body 12 or secured on the basic body 12 as a separately produced component.

Instead of the film hinge 43 and of the restoring means (not illustrated), it is also conceivable to provide a separate elastic component or a separate elastic portion which connects the one-sided lever 40 to the basic body 12.

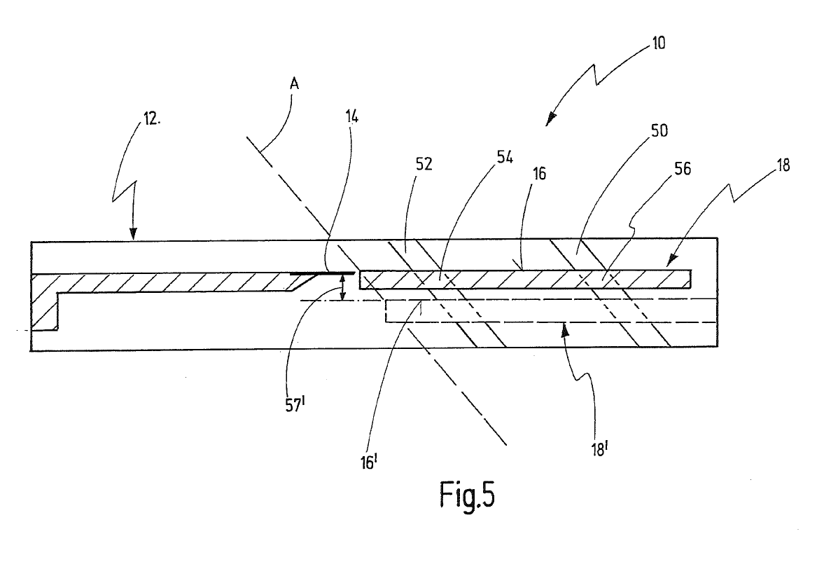

FIG. 5 illustrates, schematically, the kitchen slicer 10 according to the invention in a sectional illustration along a main axis of the basic body 12. This illustration serves to explain the offsetting of the insert 18 in relation to the blade 14. Of course, elements providing for ergonomic handling (such as a handle) may be present, and edges which are illustrated in angular fashion in the figures may be rounded in practice.

The kitchen slicer 10 illustrated in FIG. 5 with the basic body 12 and the blade 14, which is secured on the basic body 12, shows the insert 18, 18′ in two different positions. Ramp guides 50, 52 are formed in the basic body 12 and, by means of these guides, the insert 18 is mounted such that it can be moved on the basic body 12 via sliding elements 54, 56. The ramp guides 50, 52 are two or more axially spaced-apart parallel guides which may be designed as shoulders or grooves in the basic body 12. The sliding elements 54, 56 are elements on the insert 18 which engage in the ramp guides 50, 52, or butt against the same, and thus mount the insert 18 such that it can be moved in relation to the basic body 12. In a preferred configuration, the insert 18 can be offset upward relative to the basic body 12, with the aid of the ramp guides 50, 52 and the sliding elements 54, 56, to such an extent that a top side of the insert 18, on an end side directed toward the blade 14, is positioned above the blade. This position is shown in FIG. 5 by solid lines. This position of the insert 18 serves as a safety position and safeguards against accidental contact with the blade 14.

An example of an operating position for cutting items with a certain cutting thickness 57′ is illustrated in FIG. 5 by dashed lines. The cutting thickness 57′ arises from the offsetting in height between the blade 14 and the guide surface 16′. In this illustration, the insert 18, 18′ is offset parallel relative to the basic body 12 along an oblique line A. This offsetting of the insert 18, 18′ along the line A is governed by the positioning and configuration of the ramp guides 50, 52 and of the sliding elements 54, 56. These mean that it is possible for the insert 18′ to be moved out of the operating position into another position, e.g. into the illustrated safety position of the insert 18, 18′, by virtue of being displaced in the direction of the blade 14. As a result of the specific embodiment of the ramp guides 50, 52 and of the sliding elements 54, 56, the displacement of the insert 18, 18′ in the direction of the blade 14 inevitably gives rise to vertical offsetting in relation thereto.

By virtue of this method of mounting the insert 18, 18′ relative to the basic body 12, the insert 18, 18′, by being fixed in a longitudinal direction of the basic body 12, is also secured in a direction perpendicular thereto.

It is conceivable for the ramp guides 50, 52 to be formed as channels, grooves, edges or raised strips on the basic body 12 or the insert 18. The sliding elements 54, 56 may be formed as edges, pegs, grooves or channels on the insert 18 or the basic body 12. It is usually the case that two to four pairs, each comprising a respective one of the ramp guides 50, 52 and a respective one of the sliding elements 54, 56, are provided on each side of the insert 18.

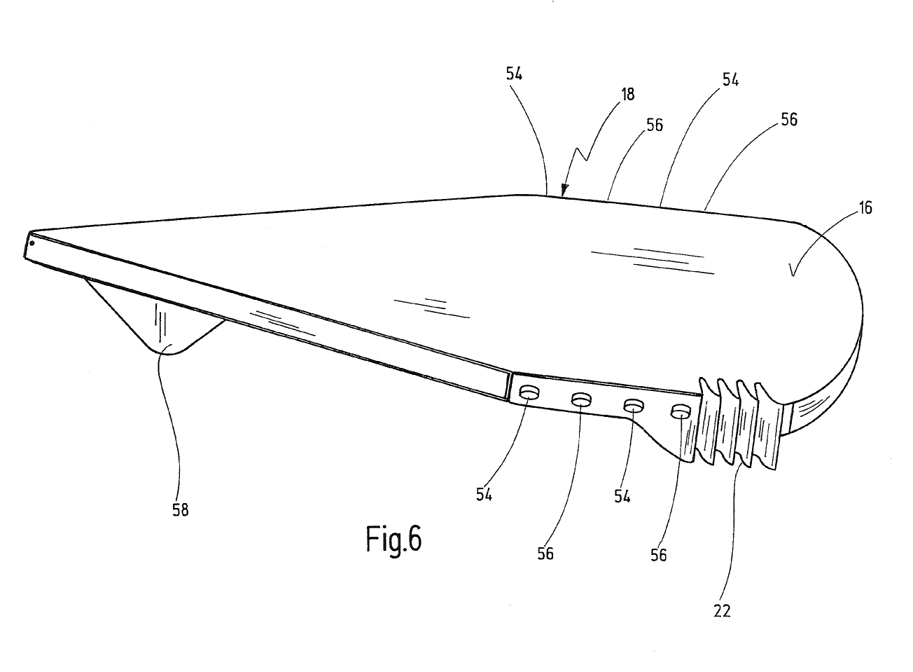

FIG. 6 illustrates, in perspective, an embodiment of the insert 18 of the kitchen slicer 10 according to the invention.

The insert 18 illustrated forms the guide surface 16. The insert 18 has, on a side edge, the sliding elements 54, 56, which in this embodiment are in the form of raised round pegs. Also on a side edge, the insert 18 has the grooves 22, with the aid of which the insert 18 is secured in different positions relative to the basic body 12. A ramp wedge 58 is arranged on an underside of the insert 18, the underside being directed away from the guide surface 16. The ramp wedge 58, in this embodiment, is designed as a flat triangular element which is arranged orthogonally to the guide surface 16 and parallel to a main axis of the insert 18.

Since the grooves 22 are arranged on an outer side of the side edges of the insert, this embodiment of the insert 18, due to the functioning of the two-sided lever 24, is used preferably together with just the embodiment illustrated in FIG. 2.

The sliding elements 54, 56 serve for mounting the insert 18 on the basic body 12. Depending on the configuration of the ramp guides 50, 52 on the basic body 12, the insert 18 can be offset parallel relative to the basic body 12. The grooves 22 serve to secure the insert 18 in different positions. The ramp wedge 58 serves as a further support for the insert 18 in relation to the basic body 12. The ramp wedge 58 is configured such that, in any position which the insert 18 can assume in relation to the basic body 12, it butts against the basic body 12.

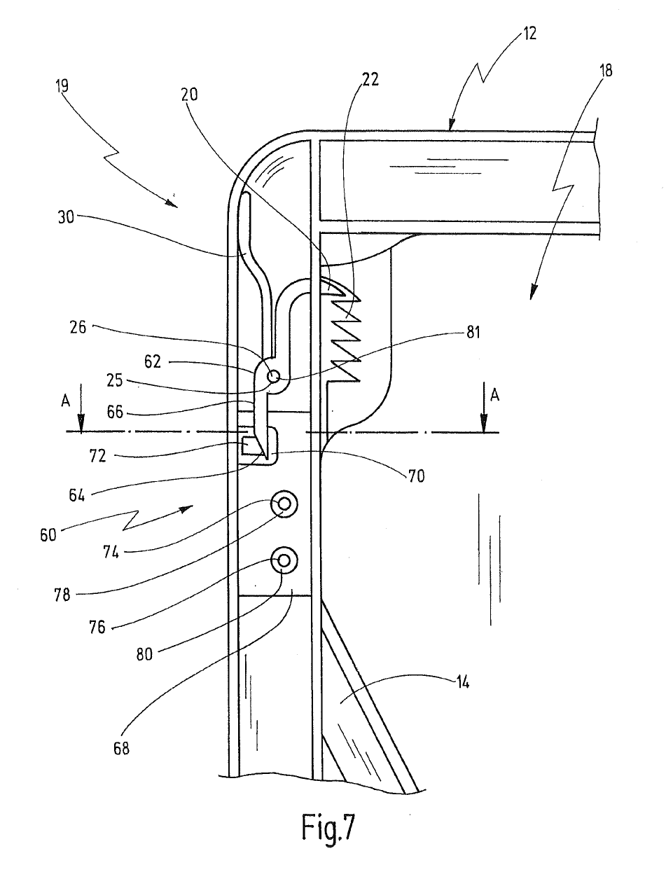

FIG. 7 illustrates, schematically from beneath, a view of part of the basic body 12 of the kitchen slicer 10 of a third embodiment, with a separate actuating element 60.

The third embodiment, which is illustrated in FIG. 7, is similar to the embodiment from FIG. 2 and corresponds to the latter in respect of construction and functioning, the same elements being indicated by the same designations. Certain differences between the embodiments will be explained hereinbelow.

The securing means 19 have a two-sided lever 62 which is mounted on the peg 26, by means of the fastening hole 25, such that it can be rotated on the basic body 12. The two-sided lever 62 has the elastic element 30, as a result of which the catch 20 is forced into one of the grooves 22 of the insert 18 and thus secures the insert 18 relative to the basic body 12. The two-sided lever 62 has an actuating portion 64 at an actuating end 66, which is located opposite the catch 20.

Formed on the basic body 12 is a shoulder 68, on which the actuating element 60 is secured. The actuating element 60, in this embodiment, can be actuated from the top side. The shoulder 68 contains an opening 70 through which an actuating pin 72 of the actuating element 60 projects. The shoulder 68 also has two mounting holes 74, 76, through which a respective mounting pin 78, 80 of the actuating element 60 is guided.

The actuating element 60 is mounted in the mounting holes 74, 76 by means of the mounting pins 78, 80 such that the actuating element can be moved in a direction parallel to an axis of rotation 81, about which the two-sided lever 62 is mounted in a rotatable manner. That is to say, the actuating element is mounted such that it can be moved perpendicularly to the guide surface 16. The mounting pins 79, 80, together with the mounting holes 74, 76, form slide bearings. The actuating pin 72 and the mounting pins 78, 80 are preferably connected integrally to the actuating element 60. As a result of the movement of the actuating element 60, the actuating pin 72 is brought into engagement with the actuating portion 64 of the two-sided lever 62 and the actuating portion 64 is deflected in the direction of the insert 18. The catch 20 is thus moved away from the insert 18, and the catch 20 and the groove 22 are therefore disengaged from one another.

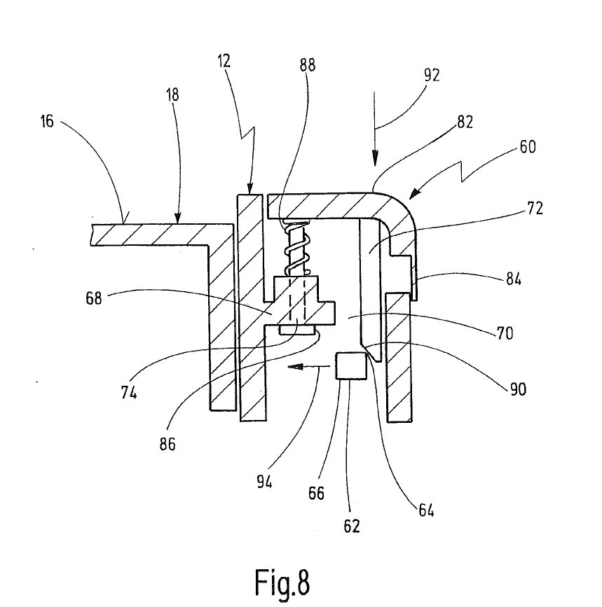

FIG. 8 illustrates a sectional view of the third embodiment of the kitchen slicer according to the invention along line A-A in FIG. 7.

The actuating element 60 has an actuating portion 82. The actuating element 60 also has the actuating pin 72 and the mounting pins 78, 80, of which only the mounting pin 78 is illustrated in FIG. 8. The actuating element 60 is secured on the basic body 12 such that the actuating portion 82 forms more or less a planar portion with the adjacent basic body 12. The actuating element 60 has, on a lateral portion, a cover panel 84, which has a bottom end butting against the basic body 12 and is offset laterally in relation to the basic body 12. The basic body 12 has the shoulder 68, in which are formed the mounting holes 74, 76, of which only the mounting hole 74 is shown in this illustration. The mounting pin 78 is guided through the mounting hole 74. The mounting pin 78 has, at a bottom end, a radially projecting periphery 86, which engages on the shoulder 68 behind a periphery of the mounting hole 74. The periphery 86 forms a stop on the shoulder 68. A spring 88 is arranged on the mounting pin 78, between the actuating portion 82 and the shoulder 68. The mounting pins 78, 80 are preferably of identical design.

The shoulder 68 has the opening 70. The actuating pin 72 is guided through the opening 70. The actuating pin 72 has an actuating portion 90 at a bottom end. The actuating portion 90 is formed obliquely relative to a longitudinal direction of the actuating pin 72 and/or relative to the movement direction of the actuating element 60. The actuating portion 90 butts against the actuating portion 64 of the two-sided lever 62. The actuating portion 64 of the two-sided lever 62 is preferably inclined, to be precise parallel to the actuating portion 90 of the actuating pin 72. In a variant of this embodiment, at least one of the actuating portions 64, 90 may be curved.

By virtue of the mounting pins 78, 80 being mounted in the mounting holes 74, 76, the actuating element 60 is mounted such that it can be moved perpendicularly to the guide surface 16. The spring 88 is supported on the actuating portion 82 and the shoulder 68 and forces the actuating element 60 away from the shoulder 68. The periphery 86 of the mounting pin 78, this periphery engaging behind the periphery of the mounting hole 74, forms a stop and prevents the mounting pin 78 from being forced out of the mounting hole 74. The spring 88 moves the actuating element 60 into an upper position without any force being applied externally. In this upper position, the actuating portion 90 of the actuating pin 72 butts against the actuating portion 64 of the two-sided lever 62 without the two-sided lever 62 being subjected to force and/or without the catch 20 being moved out of the groove 22.

If the actuating portion 82 of the actuating element 60 is subjected to force from above in the direction of an arrow 92, that is to say in the direction parallel to the axis of rotation 81, the actuating portion 90 of the actuating pin 72 presses against the actuating portion 64 of the two-sided lever 62. Since the actuating portion 90 is arranged obliquely in relation to the direction of the arrow 92 and/or obliquely in relation to the movement direction of the actuating pin 72, the actuating portion 90 subjects the actuating portion 64 of the two-sided lever 62 to force orthogonally to the direction of the arrow 92. The direction of this resultant force is indicated by an arrow 94. The actuating end 66 of the two-sided lever 62 is thus moved in the direction of the insert 18. This has the same effect as the actuation of the actuating portion 23 in the first embodiment, which is illustrated in FIG. 2.

The spring 88 causes the actuating element 60 to be moved back into the upper position following the application of force. The cover panel 84 means that the basic body is closed laterally in any position of the actuating element.

It may be advantageous if the actuating pin 72 is supported in the opening 70 in the shoulder 68 or the basic body 12 by way of a side which is located opposite the actuating portion 90. This gives the actuating pin 72 more stability when force is being applied.

Of course, all the embodiments illustrated may be combined with one another. The following combinations should be mentioned explicitly.

It is conceivable for the two-sided lever 62 to be designed as a one-sided lever which is mounted in a rotatable manner on the peg 26. Such a lever is supported on the basic body 20 by means of the elastic element 30. For the purpose of actuating this lever, it is conceivable for the actuating pin 72 to act on that end of the lever which is directed toward the catch 20 and to move this lever away from the insert 18 by virtue of the actuating portion 82 being actuated.

Furthermore, it is also possible to combine a one-sided lever, as is illustrated in FIG. 4, with the separate actuating element 60. It would be possible here for the actuating portion 90 of the actuating pin 72 to act on the free end 44 of the one-sided lever 40. It is also conceivable here for the groove 38 and the catch 48, illustrated in FIG. 4, to be formed the other way round, that is to say as is illustrated in FIGS. 2 and 7. Actuation of the actuating portion 82 then causes the actuating pin 72 to move the free end 44 such that the catch 42; 48 and the groove 22; 38 are disengaged from one another.

It would also be conceivable to combine the actuating element 60 with the slide 32 of the second embodiment, as is illustrated in FIG. 3. In this case, the catch 36 and the grooves 38 could also be arranged the other way round, as is illustrated in FIGS. 2 and 7. In such a combination, the slide 32 is moved by an elastic element such that the catch 36 and the grooves 38 are brought into engagement. The actuating pin 72 of the actuating element 60 acts on the slide 32 such that, by virtue of the actuating portion 82 being actuated, the catch 36 and the grooves 38 are disengaged from one another.

What is claimed is:

1. A kitchen slicer for cutting items, comprising:
a basic body on which a blade is secured in order for pieces to be cut off from the item,
a guide surface which is offset in relation to the blade and on which the item can be moved back and forth and fed in a controlled manner to the blade, the offsetting between the blade and the guide surface determining a cutting thickness of the pieces which are to be cut,
an insert, the upper surface of which forms the guide surface and which can be moved as a whole and secured in different positions on the basic body in order thus to realize different cutting thicknesses, and
a securing device which secure the insert relative to the basic body,
wherein the securing device has at least one component which is produced separately from the basic body and from the insert and is mounted such that it can be moved relative to the basic body in order to secure and to release the insert.

2. The kitchen slicer as claimed in claim 1, wherein the basic body has an opening through which the securing device can be actuated.

3. The kitchen slicer as claimed in claim 2, wherein the opening is formed on a longitudinal side of the basic body, on a portion adjacent to the insert.

4. The kitchen slicer as claimed in claim 1, wherein the securing device has a lever and a separate actuating element, it being possible for the actuating element to be brought into engagement with the lever in order to secure or release the insert.

5. The kitchen slicer as claimed in claim 4, wherein the lever is mounted such that it can be rotated about an axis of rotation, and wherein the actuating element is mounted such that it can be moved in a direction parallel to the axis of rotation.

6. The kitchen slicer as claimed in claim 2, wherein the securing means have an actuating portion via which the securing means can be actuated the opening at least partially encloses the actuating portion.

7. The kitchen slicer as claimed in claim 1, wherein the separately produced component has a two-sided lever.

8. The kitchen slicer as claimed in claim 7, wherein the two-sided lever is mounted such that it can be rotated about an axis arranged perpendicularly to the guide surface.

9. The kitchen slicer as claimed in claim 7, wherein the two-sided lever is inserted in the basic body from a side which faces away from the guide surface.

10. The kitchen slicer as claimed in claim 7, wherein the two-sided lever is mounted in a rotatable manner by means of a peg secured on the basic body.

11. The kitchen slicer as claimed in claim 1, wherein the separately produced component has a slide which is mounted such that it can be moved transversely to an adjusting direction of the insert.

12. The kitchen slicer as claimed in claim 1, wherein the securing device has a one-sided lever.

13. The kitchen slicer as claimed in claim 1, wherein the securing device secures the insert in a form-fitting or force-fitting manner.

14. The kitchen slicer as claimed in claim 1, wherein the securing device is assigned an elastic element such that, in a non-loaded state, the securing device secures the insert relative to the basic body.

15. The kitchen slicer as claimed in claim 1, wherein the insert can be secured in a stepwise manner relative to the basic body.

16. The kitchen slicer as claimed in claim 1, wherein the securing device has a catch and a plurality of grooves, the insert being secured in the different positions by virtue of the catch engaging in a respective one of the grooves.

17. The kitchen slicer as claimed in claim 16, wherein the catch and the grooves have such a profile that, by virtue of the insert being subjected to the action of force, the insert can be displaced with latching action in a first direction and locks in a direction which is counter to the first direction.

18. The kitchen slicer as claimed in claim 1, comprising ramp guides on which sliding elements of the insert slide such that a displacement of the insert in the direction of the blade gives rise, at the same time, to the insert being offset perpendicularly thereto.

19. A kitchen slicer for cutting items, comprising:
a basic body on which a blade is secured in order for pieces to be cut off from the item,
a guide surface which is offset in relation to the blade and on which the item can be moved back and forth and fed in a controlled manner to the blade, the offsetting between the blade and the guide surface determining a cutting thickness of the pieces which are to be cut,
an insert, the upper surface of which forms the guide surface and which can be moved as a whole and secured in different positions on the basic body in order thus to realize different cutting thicknesses, and
securing device which secures the insert relative to the basic body,
wherein the basic body has an opening through which the securing device can be actuated.

20. The kitchen slicer as claimed in claim 19, characterized in that the opening is formed on a longitudinal side of the basic body, on a portion adjacent to the insert.

21. A kitchen slicer for cutting items, comprising:
a basic body on which a blade is secured in order for pieces to be cut off from the item,
a guide surface which is offset in relation to the blade and on which the item can be moved back and forth and fed in a controlled manner to the blade, the offsetting between the blade and the guide surface determining a cutting thickness of the pieces which are to be cut,
an insert, the upper surface of which forms the guide surface and which can be moved as a whole and secured in different positions on the basic body in order thus to realize different cutting thicknesses, and
securing device which secures the insert relative to the basic body,
wherein the securing device has a lever and a separate actuating element, it being possible for the actuating element to be brought into engagement with the lever in order to secure or release the insert.

22. The kitchen slicer as claimed in claim 21, wherein the lever is mounted such that it can be rotated about an axis of rotation, and wherein the actuating element is mounted such that it can be moved in a direction parallel to the axis of rotation.
